(19) United States
(12) Patent Application Publication
(10) Pub. No.: US 2021/0365267 A1
(43) Pub. Date: Nov. 25, 2021

(54) METHOD AND APPARATUS FOR INSTRUCTION EXPANSION FOR EMBEDDED DEVICE

(71) Applicant: Electronics and Telecommunications Research Institute, Daejeon (KR)

(72) Inventors: Jinyong LEE, Daejeon (KR); Dong Wook KANG, Daejeon (KR); Donghyeun KWON, Daejeon (KR); Byeong Cheol CHOI, Daejeon (KR)

(73) Assignee: Electronics and Telecommunications Research Institute, Daejeon (KR)

(21) Appl. No.: 17/326,132

(22) Filed: May 20, 2021

(30) Foreign Application Priority Data
May 21, 2020 (KR) 10-2020-0061123

(51) Int. Cl. G06F 9/30; G06F 9/38; G06F 9/50

(52) U.S. Cl. CPC G06F 9/30181; G06F 9/5016; G06F 9/3867; G06F 9/30101

(57) ABSTRACT

Disclosed are a method and an apparatus for expanding an instruction for an embedded device. According to the method, a first instruction group and a second instruction group are set and different regions of a memory for each of the first instruction group and the second instruction group using a preset register are allocated so that the first instruction group and the second instruction group access different regions of the memory.

### CROSS-REFERENCE TO RELATED APPLICATION

This application claims priority to and the benefit of Korean Patent Application No. 10-2020-0061123 filed in the Korean Intellectual Property Office on May 21, 2020, the entire contents of which are incorporated herein by reference.

### BACKGROUND OF THE INVENTION

### (a) Field of the Invention

The present disclosure relates to an instruction extension method, and more particularly, to a method and an apparatus for instruction extension for a security solution of an embedded device.

### (b) Description of the Related Art

There are a number of program generation technologies that have enhanced security from various vulnerabilities or attacks for safer execution of various programs running on a computing device. For example, in compiler toolchains such as a GNU compiler collection (GCC) and a low level virtual machine (LLVM), which are well known today, a number of code generation technologies that allow a target program to detect various vulnerabilities or attacks in the compilation stage, such as a code generation function to detect a built-in stack overflow vulnerability, code generation techniques to depend against code reuse attack, and the like are widely used. In line with this trend, various processor architectures are also providing additional instructions by expanding their instruction set to implement these functions more safely and efficiently.

However, due to issues such as performance or price, most of these instruction sets are applicable only to high-performance devices. Therefore, an instruction set for implementing an efficient security solution for embedded devices is required.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present disclosure has been made in an effort to provide a method and an apparatus for extending and providing an instruction capable of implementing various efficient security code generation functions suitable for an embedded device.

According to an embodiment of the present disclosure, a method of extending an instruction for an embedded device is provided. The method includes: setting a first instruction group and a second instruction group; and allocating different regions of a memory for each of the first instruction group and the second instruction group using a preset register so that the first instruction group and the second instruction group access different regions of the memory.

In an implementation, the allocating of different regions of a memory may include allocating a first bit of the preset register to the first instruction group and allocating a second bit of the preset register to the second instruction group.

In an implementation, the first bit may include a set number of lower bits of the preset register, and the second bit may include a set number of upper bits of the preset register.

In an implementation, the allocating of different regions of a memory may include: adjusting a value of the first bit of the preset register to indicate a region of the memory to which an instruction of the first instruction group is accessible and adjusting a value of the second bit of the preset register to indicate a region of the memory to which an instruction of the second instruction group is accessible.

In an implementation, the method may further include setting a special instruction accessible to the preset register. In this case, the allocating of different regions of a memory may include performing memory region allocation for each of the first instruction group and the second instruction group using the preset register based on the special instruction.

In an implementation, the setting may include setting existing instructions to the first instruction group, adding a group including at least one additional instruction in addition to the first instruction group, and setting the added group to the second instruction group.

In an implementation, the setting may include setting unsecured instructions to the first instruction group and setting secured instructions to the second instruction group.

In an implementation, the instruction may be an instruction based on a reduced instruction set computer-V (RISC-V) architecture.

According to another embodiment of the present disclosure, an apparatus for extending an instruction for an embedded device is provided. The apparatus includes a memory, and a processor connected to the memory and configured to expand an instruction, wherein the processor is configured to set a first instruction group and a second instruction group and allocate different regions of the memory for each of the first instruction group and the second instruction group using a preset register so that the first instruction group and the second instruction group access different regions of the memory.

In an implementation, the processor may be configured to allocate a first bit of the preset register to the first instruction group and allocate a second bit of the preset register to the second instruction group.

In an implementation, the first bit may include a set number of lower bits of the preset register, and the second bit may include a set number of upper bits of the preset register.

In an implementation, the processor may be configured to adjust a value of the first bit of the preset register to indicate a region of the memory to which an instruction of the first instruction group is accessible and adjust a value of the second bit of the preset register to indicate a region of the memory to which an instruction of the second instruction group is accessible.

In an implementation, the processor may be further configured to set a special instruction accessible to the preset register, and perform memory region allocation for each of the first instruction group and the second instruction group using the preset register based on the special instruction.

In an implementation, the processor may be configured to set existing instructions to the first instruction group, add a group including at least one additional instruction in addition to the first instruction group, and set the added group to the second instruction group.

In an implementation, the processor may be configured to set unsecured instructions to the first instruction group and set secured instructions to the second instruction group.

### BRIEF DESCRIPTION OF THE DRAWINGS

FIG. 1 is a diagram showing an instruction according to an embodiment of the present disclosure.

FIG. 2 is a diagram showing an opcode according to an embodiment of the present disclosure.

FIG. 3 is a diagram showing the structure of a register according to an embodiment of the present disclosure.

FIG. 4 is a flowchart of a method of expanding an instruction according to an embodiment of the present disclosure.

FIG. 5 is a diagram showing the structure of an apparatus for expanding an instruction according to an embodiment of the present disclosure.

### DETAILED DESCRIPTION OF THE EMBODIMENTS

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification, unless explicitly described to the contrary, the word “comprise”, and variations such as “comprises” or “comprising”, will be understood to imply the inclusion of stated elements but not the exclusion of any other elements.

The expressions described in the singular may be interpreted as singular or plural unless an explicit expression such as “one”, “single”, and the like is used.

In addition, terms including ordinal numbers such as “first” and “second” used in embodiments of the present disclosure may be used to describe components, but the components should not be limited by the terms. The terms are only used to distinguish one component from another. For example, without departing from the scope of the present disclosure, a first component may be referred to as a second component, and similarly, the second component may be referred to as the first component.

Hereinafter, a method and an apparatus for instruction extension for a security solution of an embedded device according to an embodiment of the present disclosure will be described with reference to the drawings.

Look at the processor instruction set extension function for security.

Among the widely used processor architectures, Intel architecture (Intel x86 architecture), which is widely used in PCs and servers, supports additional instruction sets, such as segmentation, memory protection key (MPK), memory protection extension (MPX), for processor instructions for security. It The segmentation is a technology that emerged before the emergence of memory management techniques using paging in the prior art, and provides a function that allows access only by using a corresponding segment register for each memory region which is called a segment. The MPK is a function that allows allocation of a kind of identification called a protection key for each memory page, separate from setting memory access permission through a permission bit of a page table, and sets a separate memory permission for each of IDs. In addition, the MPX is a function that defines bounds so that access is allowed only within the allowed bounds whenever a memory is accessed, and allows access of the memory only when these bound checks are passed.

Meanwhile, an advanced RISC machine (ARM) architecture, which is widely used in mobile devices, continuously provides an additional instruction set for security, and some of the typical functions are as follows. Domain is a function similar to Intel's MPK, which allows domain numbers to be assigned for each memory page and to set separate memory access rights for each domain. Memory tagging extension (MTE) is a function that assigns a tag to an allocated region of a memory in performing memory allocation, and makes it possible to compare the tag of the instruction to be accessed with the tag of the corresponding memory region whenever the corresponding region is accessed, so it is used to implement a security solution for catching vulnerabilities or bugs.

There are various processor instruction set extensions that can be used to implement such a security solution, but processors such as the Cortex-M series used in embedded devices are not equipped with these extension functions for reasons such as performance and price. For example, in the case of MTE, additional memory overhead is required to store tag information for every memory word, but such memory overhead may limit actual use in an embedded device where weight reduction is an important issue.

In an embodiment of the present disclosure, by utilizing an open source architecture, such as a reduced instruction set computer-V (RISC-V) architecture, a method for processor instruction set expansion that can be used to implement various security solutions and may be efficient in an embedded device is provided.

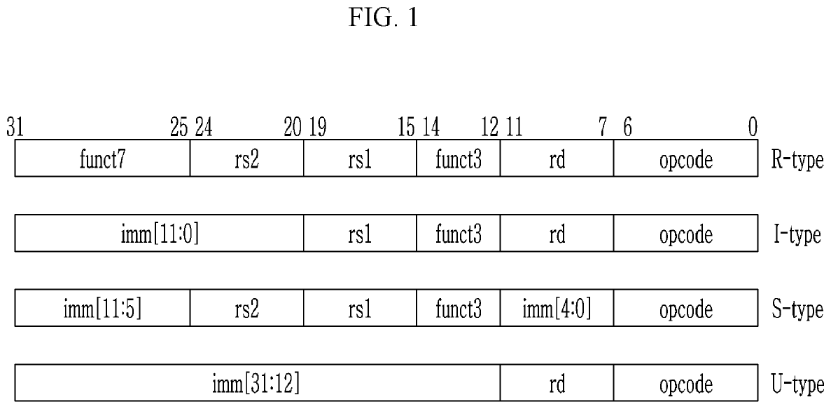

FIG. 1 is a diagram showing an instruction according to an embodiment of the present disclosure.

In the RISC-V instruction set, instructions of a predetermined length, for example, 32 bits, have a structure as shown in FIG. 1. As shown in FIG. 1, although the sub-type of the instruction differs according to the number or type of operands that are address parts to be accessed, the 0th to 6th bits represent opcodes, which are operators.

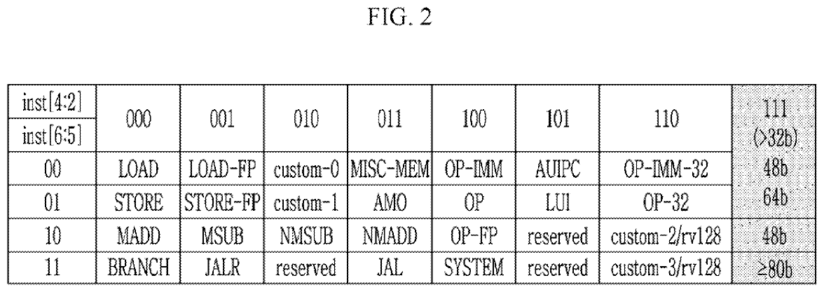

FIG. 2 is a diagram showing an opcode according to an embodiment of the present disclosure.

Specifically, FIG. 2 shows a RISC-V-based opcode map (inst[1:0]=11).

All integer memory read/write instructions have opcode values of 0b0000011 (LOAD) and 0b0100011 (STORE) in common. These opcode values are determined when designing the RISC-V instruction set. For example, various branch instructions have an opcode of 0b1100011.

In an embodiment of the present disclosure, based on the instruction of the RISC-V instruction set having such a structure, an extended instruction is provided using an opcode value that does not conflict with other existing instructions among currently available opcode values. Specifically, 0b0001011 (LOAD′) and 0b0101011 (STORE′), which are opcode values that do not conflict with other instructions, among the available opcode values, are used for a memory instruction to be added. However, the present disclosure is not necessarily limited to the value of the above opcode. Through this, it does not conflict with other existing instructions defined in ISA, so it can be implemented by minimizing modification of the processor and compiler.

Meanwhile, the instruction set according to an embodiment of the present disclosure is largely composed of two groups. There are a memory read/write instruction group (group 0) (for convenience of explanation, also referred to as the first instruction group) and a memory read/write instruction group (group 1) (for convenience of description, also referred to as the second instruction group). The first instruction group corresponds to an existing instruction set for memory access such as memory read/write, and the second instruction group corresponds to an instruction set for memory access that has been added separately, can be expanded and used. In addition, an embodiment of the present disclosure provides a system control register indicating a memory region to which instructions of the first instruction group (group 0) and the second instruction group (group 1) can access, and instructions for reading and writing the system control register.

As described above, two groups of memory-accessible instruction sets can implement the function of defining a region that each group of instructions can access. RISC-V is an open instruction set architecture (ISA) based on RISC. Among the various functions provided by the RISC-V architecture, in an embodiment of the present disclosure, the above functions are implemented using physical memory protection (PMP). The PMP is a function that divides the total usable physical memory region into 16 regions and sets memory access rights for each region. In this case, there are separate special registers for setting memory access rights of each region, and these registers can be accessed only through special instructions, not general instructions for accessing registers or memory. In accordance with an embodiment of the present disclosure, it is necessary to be able to set an accessible region for each group's instruction set.

To this end, as one method (a fixed allocation scheme), a region to which instructions of the first instruction group (group 0) can access and a region to which instructions of the second instruction group (group 1) can access are fixedly set. For example, the first instruction group (group 0) may be set to allow access to even-numbered regions, and the second instruction group (group 1) may be set to access odd-numbered regions.

As described above, the fixed allocation scheme not only limits the flexible memory management scheme that the existing PMP attempts to provide, but may also cause problems when using shared memory between two groups in some cases.

According to an exemplary embodiment of the present disclosure, information on regions allocated to each group is dynamically managed to allow flexible memory management. To do this, a special register with a set length (for example, 32 bits) is used.

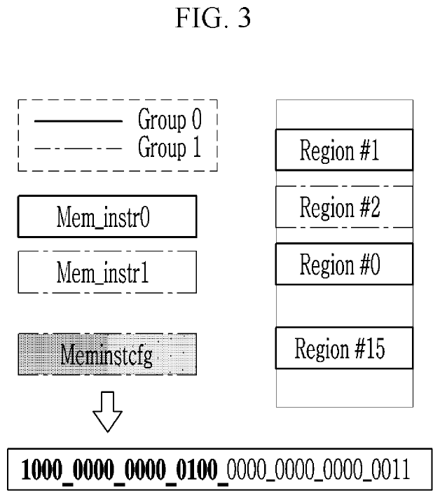

FIG. 3 is a diagram showing the structure of a register according to an embodiment of the present disclosure.

As shown in FIG. 3, in an embodiment of the present disclosure, a special register (meminstcfg) for dynamically managing information on regions allocated to an instruction set of each group is provided. The special registers are referred to as a region allocation management register. The region allocation management register (meminstcfg) has a length of 32 bits, but is not limited thereto.

In the region allocation management register (meminstcfg), as shown in FIG. 3, the lower 16 bits are used for setting the first instruction group (group 0), and the upper 16 bits are used for setting the second instruction group (group 1). Through the values of the lower 16 bits and the upper 16 bits of the allocation management register (meminstcfg), whether the instructions of the group can access the region corresponding to the bits is indicated.

For example, by setting the value of the lower 16 bits of the region allocation management register (meminstcfg) to “0000 0000 0000 0011” and the value of the upper 16 bits to “1000 0000 0000 0100”, the first instruction group (group 0) is accessible to the 0th region (Region #0) and the 1st region (Region #1) of the memory, and the second instruction group (group 1) is accessible to the 2nd region (Region #2) and the 15^{th} region (Region #15) of the memory.

Through the region allocation management register (meminstcfg) having this structure, the regions to which the instructions of the first instruction group (group 0) and the instructions of the second instruction group (group 1) can access is dynamically set and managed, so that flexible memory management can be achieved, and a shared memory between two groups can be used as needed.

On the other hand, in an embodiment of the present disclosure, access is possible only with an instruction set for the region allocation management register (meminstcfg), which is such a special register. In other words, it prevents malicious tampering using memory vulnerabilities by allowing access only with special instructions (also called preset instructions), not with arbitrary instructions. For example, it is possible to change the value of the region allocation management register through the addition of a new instruction, for example, CFGMEMINST, in a manner that does not conflict with the existing opcode, such as the addition of the LOAD′ instruction described above. This instruction can have a different format depending on the size of the region allocation management register. For example, assuming that the region allocation management register has a size of 32 bits and the value to be updated is X, it is implemented such that the high 16 bits and low 16 bits of the X value are written separately, such as CFGMEMINSTH 16BIT_HIGH_X and CFGMEMINSTL 16_BIT_LOW_X.

According to an embodiment of the present disclosure, while providing a second instruction group, which is an additionally expanded memory set, in addition to the first instruction group, which is an existing instruction set for memory access such as memory read/write, regions to which each group can access are dynamically set and managed through a special register, and these special registers are allowed to be accessed only by a special instruction set in advance, so that two groups can have access rights to different memory regions in unit of instructions. That is, memory instructions belonging to two groups are allowed to have separate memory access rights for each group.

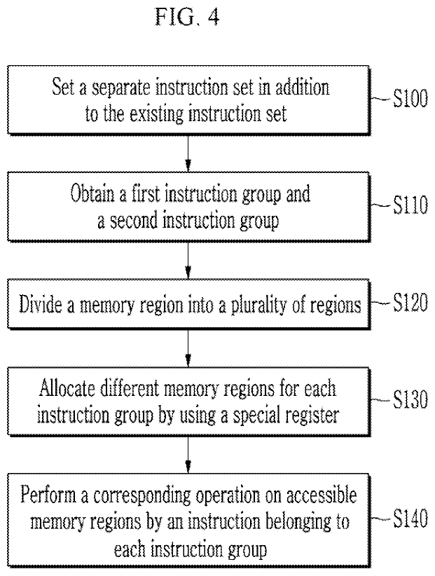

Meanwhile, a method for expanding an instruction according to an embodiment of the present disclosure can be variously applied for a security solution of an embedded device. For example, if to protect data (e.g., to protect a key used in various encryption operations), the instructions are separated into a non-secure group and a secure group as described above and then they have different access rights. In addition, only instructions belonging to the security group can access the corresponding data, so that even if there is any memory vulnerability in the code belonging to the non-security group, it is possible to prevent access to the corresponding data by the non-security group. Accordingly, it is possible to improve the security of the overall system. FIG. 4 is a flowchart of a method of expanding an instruction according to an embodiment of the present disclosure.

As shown in FIG. 4, a separate instruction set is set in addition to the existing instruction set based on the RISC-V architecture (S100). Accordingly, as described above, a first instruction group corresponding to the existing instruction set and a second instruction group corresponding to the separate memory set are obtained (S110).

The entire usable physical memory region is divided into a plurality of regions (e.g., 16 regions) (S120), and different memory regions are allocated for each instruction group (S130). To do this, a special register, the region allocation management register, is used, some bits of the region allocation management register (e.g., the lower 16 bits, also referred to as the first bit) are allocated to the first instruction group, and the remaining bits (e.g., the upper 16 bits, also referred to as the second bit) are allocated to the second instruction group. That is, the values of the first bit indicate a memory region to which instructions belonging to the first instruction group can be accessed, and the values of the first bit indicate a memory region to which instructions belonging to the second instruction group can be accessed. These special registers can only be accessed by special instructions that are set separately.

Thereafter, the instruction belonging to each instruction group performs a corresponding operation on the accessible memory region based on the value written in the corresponding bit of the special register (S140).

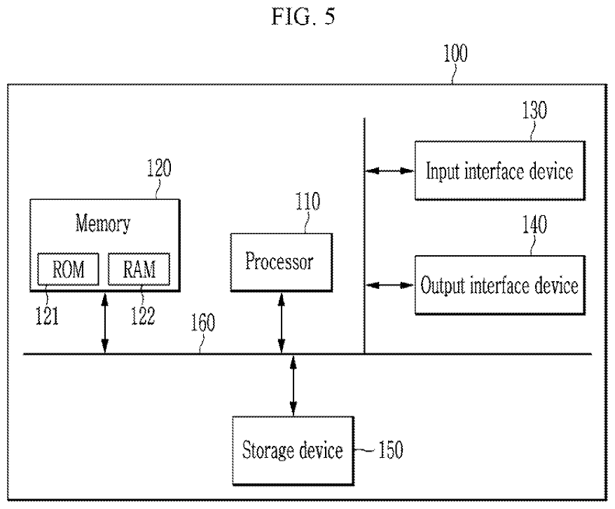

FIG. 5 is a diagram showing the structure of an apparatus for expanding an instruction according to an embodiment of the present disclosure.

An apparatus for expanding an instruction 100 includes a processor 110, a memory 120, an input interface device 130, an output interface device 140, and a storage device 150. Each of the components may be connected by a bus 160 to communicate with each other.

In addition, each of the components may be connected through an individual interface or an individual bus centered on the processor 110 instead of the common bus 160.

The processor 110 may execute a program command stored in at least one of the memory 120 and the storage device 150. The processor 110 may mean a central processing unit (CPU) or a dedicated processor for performing the forgoing methods according to embodiments of the present disclosure. The processor 110 may be configured to implement a corresponding function in the method described based on FIGS. 1 to 4 above. To this end, the processors 110 may be implemented in the form of including special registers, and the special registers may be used to dynamically set memory access rights for each group, as described above.

The memory 120 is connected to the processor 110 and stores various information related to the operation of the processor 110. For example, the memory 120 may be divided into a plurality of memory areas. The memory 120 stores instructions for an action to be performed by the processor 110, or may temporarily store an instruction loaded from the storage device 150. The memory 120 may correspond to, for example, a main memory. The processor 110 may execute instructions that are stored or loaded into the memory 120.

The memory 120 may include a ROM 121 and a RAM 122.

In an embodiment of the present disclosure, the memory 120 and the storage device 150 may be located inside or outside the processor 110, and the memory 120 and the storage device 150 may be connected to the processor 110 through various known means.

The input interface device 130 may be configured to receive data and forward the data to the processor 110, and the output interface device 130 may be configured to output the result of the processor 110.

The embodiments of the present disclosure are not implemented only through the apparatus and/or method described above, but may be implemented through a program for realizing a function corresponding to the configuration of the embodiment of the present disclosure, and a recording medium in which the program is recorded. This implementation can also be easily performed by expert person skilled in the technical field to which the present disclosure belongs from the description of the above-described embodiments.

The components described in the embodiment s may be implemented by hardware components including, for example, at least one digital signal processor (DSP), a processor, a controller, an application-specific integrated circuit (ASIC), a programmable logic element such as an FPGA, other electronic devices, or combinations thereof. At least some of the functions or the processes described in the embodiment s may be implemented by software, and the software may be recorded on a recording medium. The components, functions, and processes described in the embodiment s may be implemented by a combination of hardware and software.

The method according to embodiment s may be embodied as a program that is executable by a computer, and may be implemented as various recording media such as a magnetic storage medium, an optical reading medium, and a digital storage medium. Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages, and may be deployed in any form including a stand-alone program or a module, a component, a subroutine, or other units appropriate for use in a computing environment. A computer program may be deployed to be executed on one computer or on multiple computers at one site or distributed across multiple sites and interconnected by a communication network. Processors appropriate for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic disks, magneto-optical disks, or optical disks. Examples of information carriers appropriate for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc., and magneto-optical media such as a floptical disk, and a read only memory (ROM), a random access memory (RAM), a flash memory, an erasable programmable ROM (EPROM), and an electrically erasable programmable ROM (EEPROM), and any other known computer readable medium. A processor and a memory may be supplemented by, or integrated with, a special purpose logic circuit. The processor may run an operating system (OS) and one or more software applications that run on the OS. The processor device also may access, store, manipulate, process, and create data in response to execution of the software. For the purpose of simplicity, the description of a processor device is used as singular; however, one skilled in the art will appreciate that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media. The present specification includes details of a number of specific implementations, but it should be understood that the details do not limit any disclosure or what is claimable in the specification but rather describe features of the specific embodiment. Features described in the specification in the context of individual embodiment s may be implemented as a combination in a single embodiment. In contrast, various features described in the specification in the context of a single embodiment may be implemented in multiple embodiment s individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination. Similarly, even though operations are described in a specific order in the drawings, it should not be understood that the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described embodiment s in all embodiment s, and it should be understood that the above-described program components and apparatuses may be incorporated into a single software product or may be packaged in multiple software products. It should be understood that the embodiment s disclosed herein are merely illustrative and are not intended to limit the scope of the disclosure. It will be apparent to one of ordinary skill in the art that various modifications of the embodiment s may be made without departing from the spirit and scope of the claims and their equivalents.

What is claimed is:

1. A method for expanding an instruction for an embedded device, comprising:
setting a first instruction group and a second instruction group; and
allocating different regions of a memory for each of the first instruction group and the second instruction group using a preset register so that the first instruction group and the second instruction group access different regions of the memory.

2. The method of claim 1, wherein
the allocating of different regions of a memory comprises
allocating a first bit of the preset register to the first instruction group and allocating a second bit of the preset register to the second instruction group.

3. The method of claim 2, wherein
the first bit comprises a set number of lower bits of the preset register, and the second bit comprises a set number of upper bits of the preset register.

4. The method of claim 2, wherein
the allocating of different regions of a memory comprises
adjusting a value of the first bit of the preset register to indicate a region of the memory to which an instruction of the first instruction group is accessible and adjusting a value of the second bit of the preset register to indicate a region of the memory to which an instruction of the second instruction group is accessible.

5. The method of claim 1, further comprising
setting a special instruction accessible to the preset register,
wherein the allocating of different regions of a memory comprises performing memory region allocation for each of the first instruction group and the second instruction group using the preset register based on the special instruction.

6. The method of claim 1, wherein
the setting comprises
setting existing instructions to the first instruction group, adding a group including at least one additional instruction in addition to the first instruction group, and setting the added group to the second instruction group.

7. The method of claim 1, wherein
the setting comprises
setting unsecured instructions to the first instruction group and setting secured instructions to the second instruction group.

8. The method of claim 1, wherein
the instruction is an instruction based on a reduced instruction set computer-V (RISC-V) architecture.

9. An apparatus for expanding an instruction for an embedded device, comprising:
a memory; and
a processor connected to the memory and configured to expand an instruction,
wherein the processor is configured to set a first instruction group and a second instruction group and allocate different regions of the memory for each of the first instruction group and the second instruction group using a preset register so that the first instruction group and the second instruction group access different regions of the memory.

10. The apparatus of claim 9, wherein
the processor is configured to allocate a first bit of the preset register to the first instruction group and allocate a second bit of the preset register to the second instruction group.

11. The apparatus of claim 10, wherein
the first bit comprises a set number of lower bits of the preset register, and the second bit comprises a set number of upper bits of the preset register.

12. The apparatus of claim 10, wherein
the processor is configured to adjust a value of the first bit of the preset register to indicate a region of the memory to which an instruction of the first instruction group is accessible and adjust a value of the second bit of the preset register to indicate a region of the memory to which an instruction of the second instruction group is accessible.

13. The apparatus of claim 9, wherein
the processor is further configured to set a special instruction accessible to the preset register, and perform memory region allocation for each of the first instruction group and the second instruction group using the preset register based on the special instruction.

14. The apparatus of claim 9, wherein
the processor is configured to set existing instructions to the first instruction group, add a group including at least one additional instruction in addition to the first instruction group, and set the added group to the second instruction group.

15. The apparatus of claim 9, wherein
the processor is configured to set unsecured instructions to the first instruction group and set secured instructions to the second instruction group.
